(19) United States
(12) Patent Application Publication
(10) Pub. No.: US 2017/0048061 A1
(43) Pub. Date: Feb. 16, 2017

(54) APPARATUS FOR GENERATING RANDOM NUMBER

(71) Applicant: SAMSUNG ELECTRONICS CO., LTD., SUWON-SI (KR)

(72) Inventors: KARPINSKYY BOHDAN, SUWON-SI (KR); YONG-KI LEE, YONGIN-SI (KR); YONG-SOO KIM, OSAN-SI (KR); YUN-HYEOK CHOI, SUWON-SI (KR)

(21) Appl. No.: 15/218,530

(22) Filed: Jul. 25, 2016

(30) Foreign Application Priority Data
Aug. 12, 2015 (KR) 10-2015-0113859

(51) Int. Cl. H04L 9/06

(52) U.S. Cl. CPC H04L 9/0662

(57) ABSTRACT

An apparatus for generating a random number includes a plurality of metastability entropy sources, a first meta-ring oscillator, and a second meta-ring oscillator. The first meta-ring oscillator includes a first portion of the plurality of metastability entropy sources. The second meta-ring oscillator includes a second portion of the plurality of metastability entropy sources. Each of the first meta-ring oscillator and the second meta-ring oscillator generates a first random number based on a metastability signal in a first mode and operate as a ring oscillator and generate a second random number in a second mode. A number of metastability entropy sources included in the first meta-ring oscillator are less than a number of metastability entropy sources included in the second meta-ring oscillator. The first meta-ring oscillator includes at least one metastability entropy source.

### CROSS-REFERENCE TO RELATED APPLICATION

This application claims priority under 35 U.S.C. §119 to Korean Patent Application No. 10-2015-0113859, filed on Aug. 12, 2015, in the Korean Intellectual Property Office, the disclosure of which is incorporated by reference herein in its entirety.

### TECHNICAL FIELD

Exemplary embodiments of the present invention relate to an apparatus for generating random numbers, and more particularly, to a random number generating apparatus for generating a metastable state signal by using a logic gate.

### DISCUSSION OF RELATED ART

Metastability in electronics enables circuits to exhibit good stochastic properties. Accordingly, a true random number generator (TRNG) may use a circuit's metastability. In general, a latch or a flip-flop is employed to obtain a metastable state. However, a physical flip-flop circuit may not always stay in a metastable state. Accordingly, it may be inefficient to use the flip-flop circuit to obtain metastability.

### SUMMARY

According to an exemplary embodiment of the inventive concept, a random number generating apparatus includes a plurality of metastability entropy sources, a first meta-ring oscillator, a second meta-ring oscillator. The first meta-ring oscillator includes a first portion of the plurality of metastability entropy sources. The second meta-ring oscillator includes a second portion of the plurality of metastability entropy sources. Each of the first meta-ring oscillator and the second meta-ring oscillator generates a first random number based on a metastability signal in a first mode, and operate as a ring oscillator and generate a second random number in a second mode. A number of metastability entropy sources included in the first meta-ring oscillator may be less than the number of metastability entropy sources included in the second meta-ring oscillator. The first meta-ring oscillator includes at least one metastability entropy source.

In an exemplary embodiment of the inventive concept, in the second mode, a frequency of a first cycle signal generated by the first meta-ring oscillator may be higher than a frequency of a second cycle signal generated by the second meta-ring oscillator.

In an exemplary embodiment of the inventive concept, the random number generating apparatus may further include at least one sampling circuit. The sampling circuit may sample a first cycle signal in synchronization with a second cycle signal and output the second random number.

In an exemplary embodiment of the inventive concept, at least one of the plurality of metastability entropy sources may include an inverter and an amplifier. The inverter inverts an input signal and outputs the inverted signal. The amplifier amplifies an output signal of the inverter. In the first mode, an input terminal of the inverter may be connected to an output terminal of the inverter.

In an exemplary embodiment of the inventive concept, the random number generating apparatus may further include a plurality of metastability entropy detectors respectively connected to the plurality of metastability entropy sources. The plurality of metastability entropy detectors detect entropy of each of the metastability entropy sources in the first mode.

In an exemplary embodiment of the inventive concept, the random number generating apparatus may further include a sampling circuit to generate the second random number using the first meta-ring oscillator and the second meta-ring oscillator. The entropy detectors may be connected between the plurality of metastability entropy sources and the sampling circuit.

In an exemplary embodiment of the inventive concept, the random number generating apparatus may further include a setting circuit to connect the plurality of metastability entropy sources to one another.

In an exemplary embodiment of the inventive concept, the setting circuit may include a plurality of switching blocks. The setting circuit may control the plurality of switching blocks based on the entropy and form the first meta-ring oscillator and the second meta-ring oscillator.

In an exemplary embodiment of the inventive concept, at least one of the plurality of metastability entropy detectors may determine whether the first random number generated in the first mode by the metastability entropy source has a valid entropy by evaluating the metastability signal for a same state signal at least twice.

In an exemplary embodiment of the inventive concept, at least one of the plurality of metastability entropy detectors may include a first flip-flop, and an output signal of the metastability entropy source in the first mode may be input to a clock input terminal of the first flip-flop.

In an exemplary embodiment of the inventive concept, the at least one of the plurality of metastability entropy detectors may further include a second flip-flop. An output terminal of the first flip-flop may be connected to an input terminal of the second flip-flop. The output terminal of the metastability entropy source in the first mode may be input to the clock input terminal of the second flip-flop.

According to an exemplary embodiment of the inventive concept, there is provided a random number generating apparatus. The apparatus includes a first meta-ring oscillator and a second meta-ring oscillator. The first meta-ring oscillator includes a metastability generator to generate a metastability signal and an amplifier to amplify the metastability signal. The second meta-ring oscillator includes a plurality of random number generators. In the second meta-ring oscillator, each of the plurality of random number generators generates a metastability signal in a first mode, and the plurality of random number generators are connected to one another and operate as a ring oscillator in a second mode.

In an exemplary embodiment of the inventive concept, in the second mode, an output of the amplifier may be input to the metastability generator, and the first meta-ring oscillator may generate a first cycle signal. A second cycle signal generated by the second meta-ring oscillator in the second mode may have a lower frequency than a frequency of the first cycle signal.

According to an exemplary embodiment of the inventive concept, there is provided a metastability entropy detecting apparatus including a first storage unit, a second storage unit and a determining circuit. The first storage unit to receive and store a predetermined state signal and output the stored signal in response to a metastability signal of a metastability entropy source. The second storage unit to receive and store the predetermined state signal of the first storage unit and output the predetermined state signal in response to the metastability signal of the metastability entropy source. The determining circuit to evaluate the metastability signal based on the predetermined state signals of the first storage unit and the second storage unit.

According to an exemplary embodiment of the inventive concept, there is provided a random number generating apparatus including a plurality of metastability entropy sources, a plurality of metastability entropy detectors, and a setting circuit. The plurality of metastability entropy detectors are respectively connected to the plurality of metastability entropy sources and to detect an entropy of a metastability signal output by each of the metastability entropy sources. The setting unit to connect the plurality of metastability entropy sources to one another. A first group of metastability entropy sources, among the plurality of metastability entropy sources, are connected to one another by the setting circuit and form a first meta-ring oscillator. A second group of metastability entropy sources, among the plurality of metastability entropy sources, are connected to one another and form a second meta-ring oscillator. Each of the first meta-ring oscillator and the second meta-ring oscillator generates a first random number based on the metastability signal in a first mode, and operate as a ring oscillator and generate a second random number in a second mode.

According to an exemplary embodiment of the inventive concept, a random number generator includes a plurality of metastability entropy sources. Each of the plurality of metastability entropy sources generates a random number in a first mode. One or more meta-ring oscillators are formed from the plurality of metastability entropy sources in a second mode and that generate an output signal based on the random number. Each meta-ring oscillator includes at least one metastability entropy source.

In an exemplary embodiment of the inventive concept, the random number generator may include a first inverter, a second inverter and a multiplexer. The multiplexer may connect an output of the first inverter to an input of the first inverter in the first mode. The multiplexer may connect the output of the first inverter of a first metastability entropy source in a meta-ring oscillator to an input of the second inverter of a second metastability entropy source in the meta-ring oscillator in the second mode.

In an exemplary embodiment of the inventive concept, the random number generator may include a controller and a sampling circuit. The sampling circuit may generate a sampling signal based on the output signal from the plurality of metastability entropy sources in the second mode and a clock signal received from the controller.

In an exemplary embodiment of the inventive concept, the random number generator may include a detecting circuit. The detecting circuit may determine if each of the plurality of metastability entropy sources have entropy based on the output signal of each of the plurality of metastability entropy sources. The metastability entropy sources without entropy are excluded from meta-ring oscillators.

In an exemplary embodiment of the inventive concept, the random number generator may include a plurality of switching blocks. The plurality of switching blocks may include a plurality of transistors that connect the metastability entropy sources for the one or more meta-ring oscillators based on the determination of the detecting circuit.

### BRIEF DESCRIPTION OF THE DRAWINGS

The above and other features of the present inventive concept will become more apparent by describing in detail exemplary embodiments thereof with reference to the accompanying drawings in which:

FIG. 1 is a block diagram of a random number generating apparatus according to an exemplary embodiment of the inventive concept;

FIG. 2 is a block diagram of a random number generating apparatus according to an exemplary embodiment of the inventive concept;

FIG. 3 is a block diagram of a random number generating apparatus according to an exemplary embodiment of the inventive concept;

FIGS. 4 and 5 are graphs of output waveforms generated by the random number generating apparatus of FIG. 3, according to exemplary embodiments of the inventive concept;

FIGS. 6 and 7 are block diagrams of random number generating apparatuses according to exemplary embodiments of the inventive concept;

FIG. 8 is a block diagram of a random number generating apparatus according to an exemplary embodiment of the inventive concept;

FIG. 9 is a block diagram of a random number generating apparatus according to an exemplary embodiment of the inventive concept;

FIG. 10 is a block diagram of a random number generating apparatus according to an exemplary embodiment of the inventive concept;

FIG. 11 is a block diagram of a random number generating apparatus according to an exemplary embodiment of the inventive concept;

FIG. 12 is a block diagram of a random number generating apparatus according to an exemplary embodiment of the inventive concept;

FIGS. 13 and 14 are detailed circuit diagrams of a detector of the random number generating apparatus of FIG. 12, according to exemplary embodiments of the inventive concept;

FIG. 15 is a diagram of a modified example of the detector of FIG. 13, according to an exemplary embodiment of the inventive concept;

FIG. 16 is a schematic flowchart of a method of operating a random number generating apparatus according to an exemplary embodiment of the inventive concept;

FIG. 17 is a block diagram of a method of operating a random number generating apparatus according to an exemplary embodiment of the inventive concept;

FIG. 18 is a detailed diagram of an operation for forming a meta-ring oscillator of FIG. 17;

FIGS. 19 to 21 are diagrams of random number generating apparatuses according to exemplary embodiments of the inventive concept;

FIG. 22 is a schematic plan view of a semiconductor package including a random number generating apparatus according to an exemplary embodiment of the inventive concept;

FIG. 23 is a schematic plan view of a smart card including a random number generating apparatus according to an exemplary embodiment of the inventive concept;

FIG. 24 is a detailed circuit diagram of a semiconductor chip of the smart card of FIG. 23; and

FIG. 25 is a block diagram of a security system including a crypto processor having a random number generating apparatus according to an exemplary embodiment of the inventive concept.

### DETAILED DESCRIPTION OF THE EMBODIMENTS

The inventive concept will now be described more fully hereinafter with reference to the accompanying drawings, in which exemplary embodiments of the inventive concept are shown. This inventive concept may, however, be embodied in different forms and should not be construed as limited to the embodiments set forth herein. In an exemplary embodiment of the inventive concept, a device, module or unit may be implemented as a circuit.

Like reference numerals refer to like element throughout the specification and the drawings.

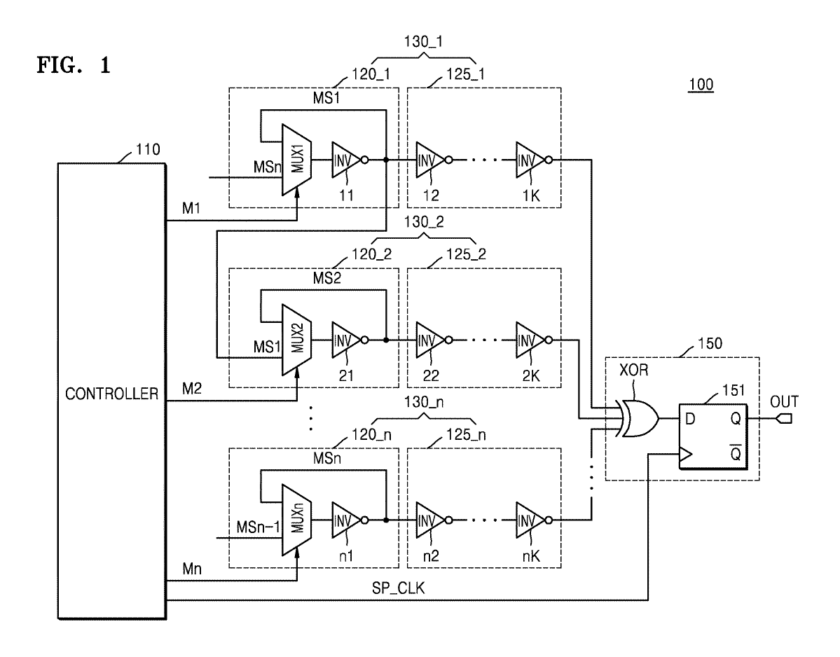

FIG. 1 is a block diagram of a random number generating apparatus 100 according to an exemplary embodiment of the inventive concept.

Referring to FIG. 1, the random number generating apparatus 100 may include a plurality of metastability entropy sources 130_1, 130_2, . . . , and 130_n. In a first mode, each of the metastability entropy sources 130_1, 130_2, . . . , and 130_n may generate a metastability signal and generate a random number by using the metastability signal. In a second mode, the plurality of metastability entropy sources 130_1, 130_2, . . . , and 130_n may be connected to one another and operate as a ring oscillator.

To this end, each of metastability generators 120_1, 120_2, . . . , and 120_n respectively included in the plurality of metastability entropy sources 130_1, 130_2, . . . , and 130_n may generate and output a metastability signal in the first mode and receive and amplify an output signal of another metastability entropy source in the second mode.

For example, when the metastability generators 120_1, 120_2, . . . , and 120_n are embodied as inverters INV11, INV21, . . . , and INVn1, in the first mode, input terminals of the inverters INV11, INV21, . . . , and INVn1 may be connected to output terminals thereof so that each of the inverters INV11, INV21, . . . , and INVn1 may generate the metastability signal. In the second mode, the input terminal of each of the inverters INV11, INV21, . . . , and INVn1 may be connected to another metastability entropy source so that each of the inverters INV11, INV21, and INVn1 may operate as a simple inverting amplifier.

In this case, the metastability generators 120_1, 120_2, . . . , and 120_n may further include multiplexers MUX1, MUX2, . . . , and MUXn, respectively, which may selectively output the input signals in response to mode signals M1, M2, . . . , and Mn being applied from a controller 110. N is a natural number.

First input terminals of the multiplexers MUX1, MUX2, . . . , and MUXn may be respectively connected to the output terminals of the metastability generators 120_1, 120_2, . . . , and 120_n. Thus, in the first mode (e.g., when the mode signals M1, M2, . . . , and Mn are in a low state), the input terminals of the inverters INV11, INV21, . . . , and INVn1 may be connected to the output terminals thereof so that each of the inverters INV11, INV21, . . . , and INVn1 may generate a metastability signal. A second input terminal of each of the multiplexers MUX1, MUX2, . . . , and MUXn may be connected to another metastability entropy source. Thus, in the second mode (e.g., when the mode signals M1, M2, . . . , and Mn are in a high state), each of the inverters INV11, INV21, . . . , and INVn1 may invert and amplify a signal generated by another metastability entropy source.

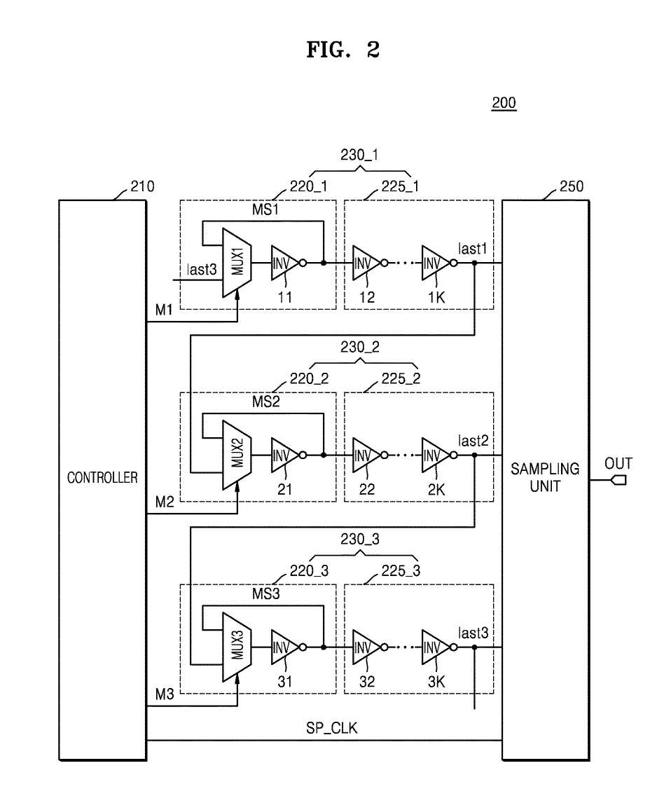

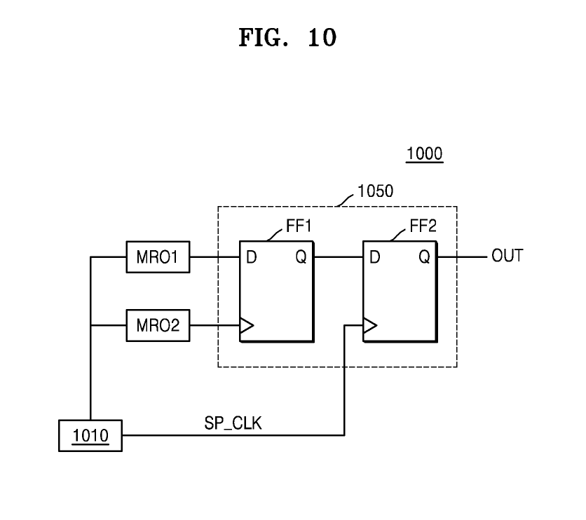

FIG. 1 illustrates a case in which the second input terminals of the multiplexers MUX1, MUX2, . . . , and MUXn are connected to the output terminals of the metastability generators 120_1, 120_2, . . . , and 120_n (e.g., the inverters INV11, INV21, . . . , and INVn1) of other metastability entropy sources, but the inventive concept is not limited thereto. As shown in FIG. 2, the second input terminals of the multiplexers MUX1, MUX2, . . . , and MUXn in FIG. 1 may be connected to the output terminals of amplifiers 125_1, 125_2, . . . , and 125_n in FIG. 10f the other metastability entropy sources. It is to be understood that other configurations of the random number generating apparatus 100, may generate a random number having metastability by using the multiplexers MUX1, MUX2, . . . , and MUXn in the first mode, and generate a random number by using the multiplexers MUX1, MUX2, . . . , and MUXn of a ring oscillator in the second mode.

A sampling unit 150 may be connected to n metastability entropy sources 130_1, 130_2, . . . , and 130_n and sample output signals of the metastability entropy sources 130_1, 130_2, . . . , and 130_n. For example, the sampling unit 150 may include an XOR gate XOR and a flip-flop 151.

The XOR gate XOR may perform a logic XOR operation on amplification signals of the first amplifier 125_1 to the n-th amplifier 125_n and output resultant signals. For example, the XOR gate XOR may output a high signal when the number of high-level amplification signals, among the input amplification signals, is an even number, and output a low signal when the number of the high-level amplification signals, among the amplification signals, is an odd number. In this case, the random number generating apparatus 100 may have a high entropy since the entropies of the respective metastability entropy sources 130_1, 130_2, and 130_n are added due to the XOR operation. Entropy may refer to an uncertainty as to whether a signal is at a high level or a low level

In an exemplary embodiment of the inventive concept, an amplifier (e.g., the first amplifier 125_1 to the n-th amplifier 125_n) may take various other forms. For example, the amplifier may include other types of logic gates or operational amplifiers with similar characteristics to the amplifier described above.

The flip-flop 151 may sample and output the output signal of the XOR gate XOR. For example, when the flip-flop 151 is a D flip-flop and a sampling clock SP_CLK applied by the controller 110 has a cycle of about 1 μs, the D flip-flop may store and output a state (e.g., a high state or a low state) of the output signal of the XOR gate XOR at intervals of about 1 μs.

Hereinafter, operations of the random number generating apparatus 100 in the first mode (e.g., a metastability mode) and the second mode (e.g., an oscillation) mode) will be described in detail.

### <First Mode: Metastability Mode>

In the first mode, a first multiplexer MUX1 of the first metastability entropy source 130_1 may, for example, receive a low-state mode signal M1 from the controller 110 and electrically connect the first input terminal of the first multiplexer MUX1 with the input terminal of the inverter INV11. Since the first input terminal of the first multiplexer MUX1 is connected to the output terminal of the inverter INV11, the input terminal of the inverter INV11 may be connected to the output terminal thereof. Thus, as described with reference to FIG. 1, the inverter INV11 may generate a metastability signal due to thermal noise.

The feedback loop described above with reference to the first metastability entropy source 130_1 may be applied to the second multiplexer MUX2 of the second metastability entropy source 130_2 through the n-th multiplexer MUXn of the n-th metastability entropy source 130_n. In this case, since each of the plurality of metastability entropy sources 130_1, 130_2, . . . , and 130_n generates a random number and transmits the random number to the sampling unit 150, the random number generating apparatus 100 may have a high entropy as shown by Equation 1.

When the sampling unit 150 includes the XOR gate XOR and the flip-flop 151 as shown in FIG. 1, an entropy obtained due to the XOR operation may be numerically expressed as follows. Assuming that an entropy of the first metastability entropy source 130_1 is ε_{MS1}, an entropy of the second metastability entropy source 130_2 is ε_{MS2}, and an entropy of the n-th metastability entropy source 130_n is ε_{Msn}, the total entropy of the random number generating apparatus 100 according to the present embodiment in the first mode may be expressed in the Equation 1:

ε_{MS}=ε_{MS1}+ε_{MS2}+ . . . +ε_{MSn}=Σε_{MSi} (1).

### <Second Mode: Oscillation Mode>

In the second mode, the first multiplexer MUX1 of the first metastability entropy source 130_1 may, for example, receive a high-state mode signal M1 from the controller 110 and electrically connect the second input terminal of the first multiplexer MUX1 with the input terminal of the inverter INV11 of the first metastability entropy source 130_1. Since the second input terminal of the first multiplexer MUX1 is connected to the output terminal of the inverter INVn1 of the n-th metastability entropy source 130_n, the input terminal of the inverter INV11 of the first metastability entropy source 130_1 may be connected to the output terminal of the inverter INVn1 of the n-th metastability entropy source 130_n. Accordingly, the inverter INV11 may invert and amplify an output signal of the inverter INVn1 of the n-th metastability entropy source 130_n.

As shown in FIG. 1, in the second mode, each of the multiplexers MUX1, MUX2, . . . , and MUXn may invert and amplify an output signal of an inverter of another metastability entropy source. For example, when the output signal of the inverter INVn1 of the n-th metastability entropy source 130_n is inverted and amplified by the inverter INV11 of the first metastability entropy source 130_1, the output signal of the inverter INV11 may be applied to the second input terminal of the second multiplexer MUX2 of the second metastability entropy source 130_2.

Similar to the first multiplexer MUX1, the second multiplexer MUX2 may also receive a high-state mode signal M2 and connect the second input terminal of the second multiplexer MUX2 with the input terminal of the inverter INV21 of the second metastability entropy source 130_2. Accordingly, the output signal output by the inverter INV11 of the first metastability entropy source 130_1 may be inverted and amplified by the inverter INV21 of the second metastability entropy source 130_2.

As a result, the connections of the first to n-th multiplexers MUX1 to MUXn cause the random number generating apparatus 100 to operate as a ring oscillator that continuously inverts and amplifies an output signal in the second mode. Since an oscillation operation is enabled by performing the inversion and amplification operations an odd number of times in an exemplary embodiment of the inventive concept, the number of metastability entropy sources may be odd. Hereinafter, the operation of the ring oscillator in an oscillation mode will be described in further detail.

<Initial Period of Second Mode (Oscillation Mode)>

The ring oscillator may perform an oscillation operation. Accordingly, the ring oscillator may repeat the transition from a high state to a low state and vice versa. When the ring oscillator is sampled at an arbitrary time point, the ring oscillator may provide a high-level voltage or a low-level voltage.

At a time point in which the ring oscillator enters the second mode, a voltage amplified by the ring oscillator may be a high-level voltage or a low-level voltage. It may not be possible to predict whether the voltage amplified by the ring oscillator is the high-level voltage or the low-level voltage because a level of the voltage is dependent upon an output signal in the first mode (e.g. the metastability mode). Accordingly, oscillation signals output by output terminals of the metastability entropy sources 130_1, 130_2, . . . and 130_n may be expressed as shown in Equation 2:

U_{osc}(t)=Uₜₕ+A sin(ω₀t+φ₀) (2)

In other words, the ring oscillator may continuously perform an inversion operation of inverting a logic level during an initial period, and output a sine-wave-type signal having a predetermined cycle. The output signal, which is a stable oscillation signal, may have a predetermined duty cycle. The sine-wave-type signal has a randomized initial phase φ₀.

Accordingly, in the initial period of the second mode (e.g. the oscillation mode), when the sampling unit 150 samples an output signal of the output terminal of each of the metastability entropy sources 130_1, 130_2, . . . , and 130_n, the output signal may randomly have a high state or a low state due to thermal noise at a sampling time point. In an exemplary embodiment of the inventive concept, even if the random number generating apparatus 100 according to the present embodiment operates as the ring oscillator in the initial period, the random number generating apparatus 100 may generate a true random number. In this case, an entropy of the random number generating apparatus 100 may be expressed by ε_{φ}_{₀}.

<After Initial Period of Second Mode (Oscillation Mode)>

After the initial period, the ring oscillator may have a jitter during an oscillation operation and output an oscillation signal having an irregular cycle.

For example, while the ring oscillator is continuously performing the oscillation operation, noises may be accumulated in the oscillation signal. Thus, the ring oscillator may output an oscillation signal having a jitter. Here, the jitter may indicate the flickering of a signal on a time axis. The oscillation signal output from the output terminal of each of the metastability entropy sources 130_1, 130_2, . . . , and 130_n may be expressed as shown in Equation 3:

U_{osc}(t)=Uₜₕ±A·sin(ω₀t+φ₀+φⱼ(t)) (3),

wherein Uₜₕ is a threshold level value, A is an amplitude of a sine function, and ω₀ is a frequency of the ring oscillator and may be expressed as in Equation 4:

$${ω}_{0} = 2 π {f}_{0} = 2 π \frac{1}{{T}_{0}} = 2 π \frac{1}{{τ}_{1} + {τ}_{2} + … + {τ}_{l}} , \qquad ( 4 )$$

wherein τᵢ denotes a time delay value of an i-th inverter.

Since the jitter is a function of time, the ring oscillator may output an oscillation signal that has an irregular cycle and an inconstant duty cycle. The random number generating apparatus 100 may perform a sampling operation based on the oscillation signal having the irregular cycle and generate a true random number. In this case, an entropy of the random number generating apparatus 100 may be expressed by ε_{φ}_{ⱼ}.

In the second mode, the entropy of the random number generating apparatus 100 may be expressed as shown in Equation 5:

ε_{RO}=ε_{φ}_{₀}+ε_{φ}_{ⱼ} (5).

### <Total Entropies of Random Number Generating Apparatus>

By adding up an entropy of the random number generating apparatus 100 in the above-described first mode, an entropy of the random number generating apparatus 100 in the initial period of the second mode, and an entropy of the random number generating apparatus 100 after the initial period of the second mode, the random number generating apparatus 100 according to the present embodiment may have a total entropy shown in Equation 6:

ε_{MRO}=ε_{MS}+ε_{RO}=Σε_{MSi}+ε_{φ}_{₀}+ε_{φ}_{ⱼ} (6).

Accordingly, the random number generating apparatus 100 according to the present embodiment may have a high entropy by adding entropies based on metastability signals generated by a plurality of metastability entropy sources in the first mode and an entropy based on an oscillation signal generated by connecting the plurality of metastability entropy sources to one another in the second mode. Thus, the random number generating apparatus 100 may generate a high-quality true random number.

FIG. 2 is a block diagram of a random number generating apparatus 200 according to an exemplary embodiment of the inventive concept. The random number generating apparatus 200 according to the present embodiment may be a modified example of the random number generating apparatus 100 according to the embodiment shown in FIG. 1. Hereinafter, repeated descriptions in the two embodiments will be omitted.

Referring to FIG. 2, as described above, the second input terminals of the multiplexers MUX1, MUX2, and MUX3 may be connected to the output terminals of the amplifiers 125_1, 125_2, and 125_3 of the other metastability entropy sources. Accordingly, in the second mode, the random number generating apparatus 200 may operate as a ring oscillator and generate an oscillation signal via the first multiplexer MUX1, the inverters INV11, INV12, and INV1k of the first metastability entropy source 230_1, the second multiplexer MUX2, the inverters INV21, INV22, and INTV2k of the second metastability entropy source 230_2, the third multiplexer MUX3, and the inverters INV31, INV32, and INV3k of the third metastability entropy source 230_3.

In other words, the oscillation signal may be continuously generated via the above-described components. It should be noted that inversion and amplification operations are performed an odd number of times to continuously generate the oscillation signal. Accordingly, the total number of inverters INV11, INV12, INV1k, INV21, INV22, INV2k, INV31, INV32, and INV3k of the first to third metastability entropy sources 230_1, 230_2, and 230_3 may be an odd number.

Since the output terminals of the amplifier 225_1, 225_2, and 225_3 have high-level voltages as an amplification result, signals applied from the output terminals of the amplifiers 225_1, 225_2, and 225_3 to the inverters INV11, INV21, and INV31 in the second mode may have high voltage levels. Accordingly, a loss of entropy due to mismatches among threshold levels of the inverters, for example, the inverters INV3k and INV11, the inverters INV1k and INV21, and the inverters INV2k and INV31 may be prevented.

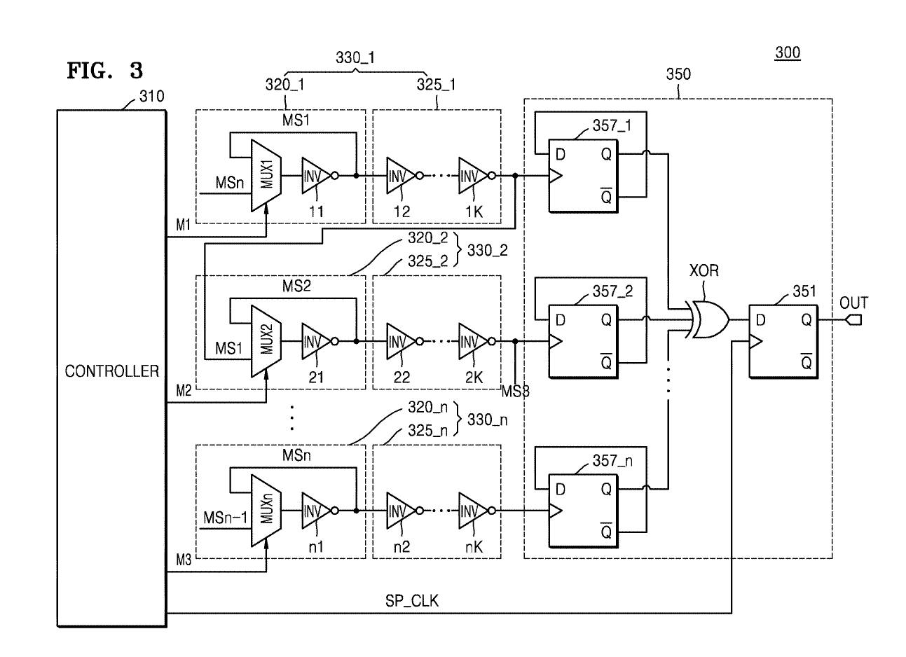

FIG. 3 is a block diagram of a random number generating apparatus according to an exemplary embodiment of the inventive concept. The random number generating apparatus 300 according to the present embodiment may be a modified example of the random number generating apparatus 100 according to the embodiment shown in FIG. 1. Hereinafter, repeated descriptions in the two embodiments will be omitted.

Referring to FIG. 3, second input terminals of a first multiplexer MUX1, a second multiplexer MUX2, . . . , and an n-th multiplexer MUXn may be connected to output terminals of metastability generators (e.g., inverters INV11, INV21, . . . , and INVn1) of another metastability entropy source or output terminals of amplifiers 325_1, 325_2, . . . , and 325_n. For example, the amplifiers 325_1, 325_2, . . . , and 325_n may include a plurality of amplification stages (e.g., inverters INV12, . . . , INV1k, inverters INV22, . . . , INV2k, inverters INVn2, . . . , and INVnk), which may amplify and output input signals. In this case, the plurality of amplification stages may be connected in series.

Similar to the exemplary embodiment of the inventive concept shown in FIG. 1, the second input terminal of the first multiplexer MUX1 of the first metastability entropy source 330_1 may be connected to the output terminal of the n-th metastability generator 320_n(e.g., the inverter INVn1) of the n-th metastability entropy source 330_n. Similar to the exemplary embodiment shown in FIG. 2, the second input terminal of the second multiplexer MUX2 of the second metastability entropy source 330_2 may be connected to the output terminal of the first amplifier 325_1 of the first metastability entropy source 330_1. A second input terminal of a third multiplexer of a third metastability entropy source may be connected to an output terminal of an amplification stage (e.g., the inverter INV22), among a plurality of amplification stages INV22, . . . , and INV2k of the second amplifier 325_2.

A sampling unit 350 may be connected to n metastability entropy sources, receive amplification signals from amplifiers 325_1, 325_2, . . . , and 325_n of the n metastability entropy sources, and sample and output the amplification signals in response to a sampling clock signal SP_CLK. For example, the sampling unit 350 may include mod 2 counters 357_1, 357_2, . . . , and 357_n, an XOR gate XOR, and a flip-flop 351.

The mod 2 counters 357_1, 357_2, . . . , and 357_n may be respectively connected to the metastability entropy sources 330_1, 330_2, . . . , and 330_n and count the numbers of rising edges of amplification signals output by the first to n-th amplifiers 325_1, 325_2, . . . , and 325_n. The mod 2 counters 357_1, 357_2, . . . , and 357_n may count the number of falling edges or the number of rising and falling edges. The mod 2 counter 357 may be embodied by a different kind of counter to perform the count function.

In the first mode, each of the mod 2 counters 357_1, 357_2, . . . , and 357_n may output 1 when the number of rising edges of an amplified metastability signal output by the corresponding one of the amplifiers 325_1, 325_2, . . . , and 325_n of the metastability entropy sources 330_1, 330_2, . . . , and 330_n is an odd number. The mod 2 counters 357_1, 357_2, . . . , and 357_n may output 0 when the number of the rising edges is an even number.

In the second mode, each of the mod 2 counter 357_1, 357_2, . . . , and 357_n may output 1 when the number of rising edges of an oscillation signal amplified by the corresponding one of the amplifiers 325_1, 325_2, . . . , and 325_n of the metastability entropy sources 330_1, 330_2, . . . , and 330_n is an odd number. The mod 2 counters 357_1, 357_2, . . . , and 357_n may output 0 when the number of the rising edges is an even number.

The XOR gate XOR may perform a logic XOR on the output signals of the n mod 2 counters 357_1, 357_2, and 357_n and output resultant signals. For example, the XOR gate XOR may output a high signal when the number of the mod 2 counters 357_1, 357_2, . . . , and 357_n to output a high state is an even number. The XOR gate XOR may output a low signal when the number of the mod 2 counters 357_1, 357_2, . . . , and 357_n to output a high state is an odd number. Since entropies of the respective metastability entropy sources 330_1, 330_2, and 330_n are added due to the XOR operation.

The flip-flop 351 may sample the output signal from the XOR gate XOR and output the sampled signal. For example, when the flip-flop 351 is a D flip-flop and the sampling clock SP_CLK applied from the controller 310 has a cycle of 1 μs, the D flip-flop 351 may store and output a state (e.g., a high state or a low state) of the output signal from the XOR gate XOR at time intervals of about 1 μs.

In the first mode and the second mode, the random number generating apparatus 300 shown in FIG. 3 may mod 2 count the number of rising edges (of a metastability signal or oscillation signal) of each of the metastability entropy sources 330_1, 330_2, . . . , and 330_n during a cycle of the sampling clock SP_CLK applied by the controller 310, perform a logic XOR operation on respective output signals of the mod 2 counter 357_1, 357_2, . . . , and 357_n, and generate 0 or 1 as a random number.

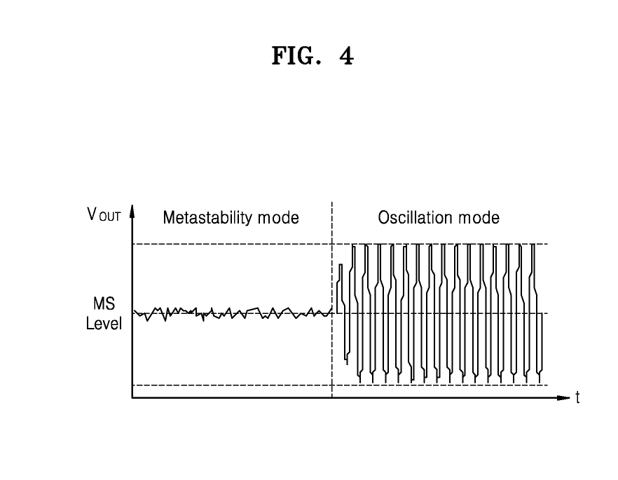

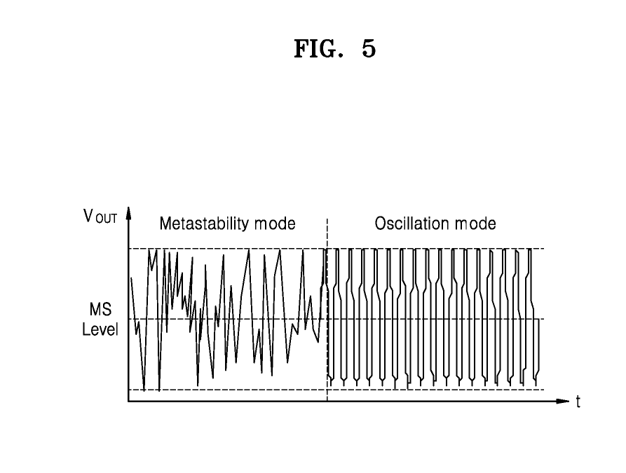

FIGS. 4 and 5 are graphs of output waveforms generated by the random number generating apparatus 300 of FIG. 3, according to an exemplary embodiment of the inventive concept.

Referring to FIGS. 4 and 5, a signal may be output from an output terminal of an n-th metastability generator 320_n of an n-th metastability entropy source 330_n. In a first mode (metastability mode), a metastability signal due to a thermal noise may be output from the output terminal. In a second mode (oscillation mode), an oscillation signal generated by inverting and amplifying the metastability signal may be output from the output terminal.

Referring to FIG. 5, a signal may be output from an output terminal of an n-th amplifier 325_n of an n-th metastability entropy source 330_n. In a first mode (metastability mode), an amplification signal generated by amplifying a metastability signal due to a thermal noise may be output from the output terminal. In a second mode (oscillation mode), an oscillation signal generated by inverting and amplifying the metastability signal may be output from the output terminal.

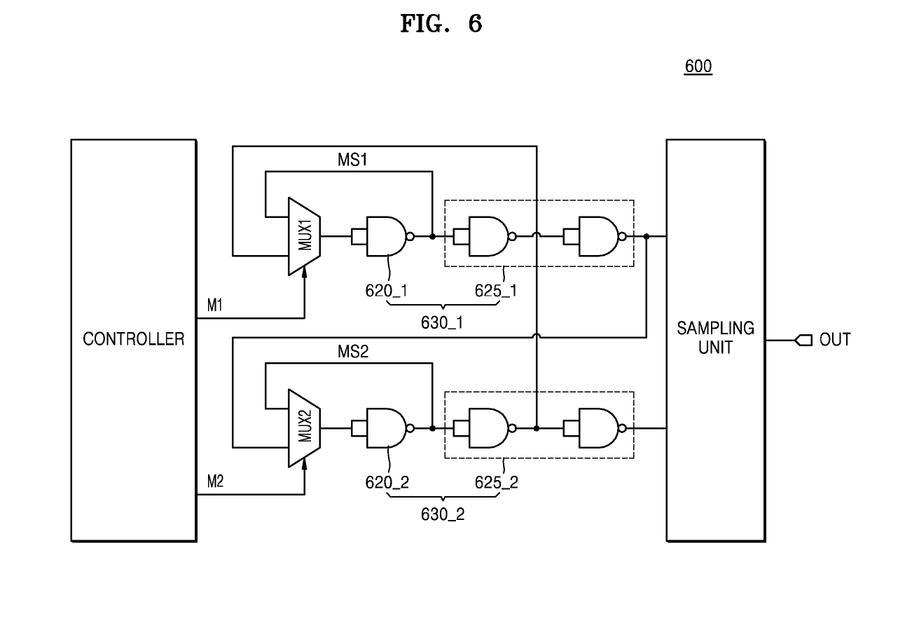

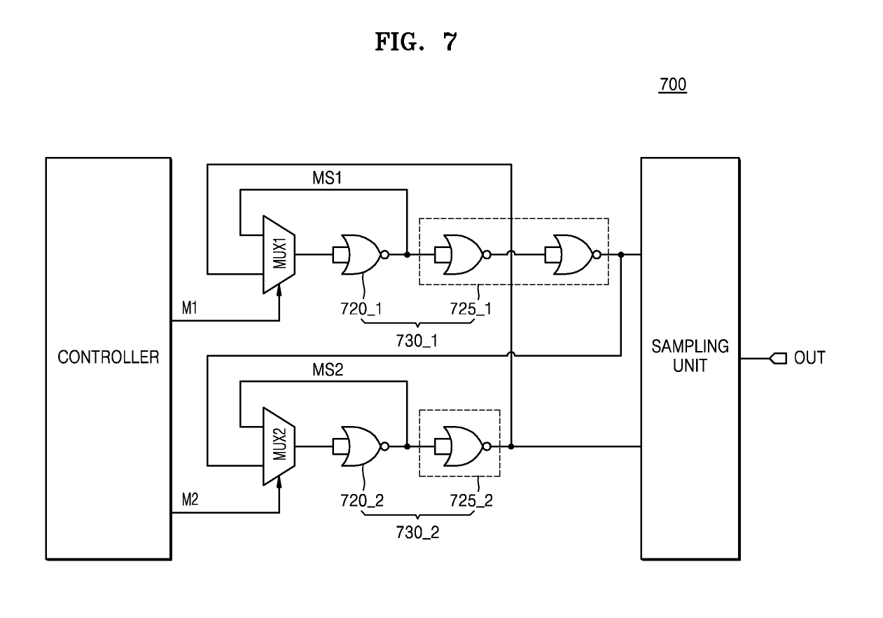

FIGS. 6 and 7 are block diagrams of random number generating apparatuses 600 and 700 according to exemplary embodiments of the inventive concept. The random number generating apparatuses 600 and 700 according to the present embodiments may be modified examples of the random number generating apparatus 100 according to the embodiment shown in FIG. 1. Hereinafter, repeated descriptions in these embodiments will be omitted.

Referring to FIGS. 6 and 7, an inverter may be replaced by a NAND gate or a NOR gate. In addition, as shown in FIG. 7, the number of amplification stages of a first amplifier 725_1 of a first metastability entropy source 730_1 may differ from amplification stages of an amplifier 725_2 of a second metastability entropy source 730_2.

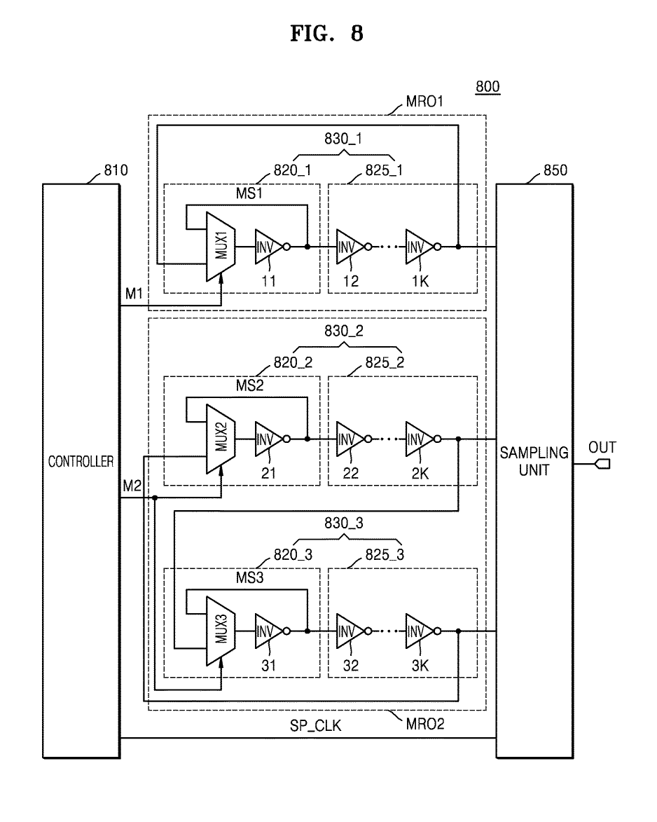

FIG. 8 is a block diagram of a random number generating apparatus 800 according to an exemplary embodiment of the inventive concept. The random number generating apparatus 800 according to the present embodiment may be a modified example of the random number generating apparatus 200 according to the embodiment shown in FIG. 2. Hereinafter, repeated descriptions in the two embodiments will be omitted.

Referring to FIG. 8, the random number generating apparatus 800 may include a plurality of metastability entropy sources, for example, first, second, and third metastability entropy sources 830_1, 830_2, and 830_3. Some of the first, second, and third metastability entropy sources 830_1, 830_2, and 830_3 may constitute a first meta-ring oscillator MRO1, while other ones of the metastability entropy sources 830_1, 830_2, and 830_3 may constitute a second meta-ring oscillator MRO2.

For example, the first meta-ring oscillator MRO1 may include the first metastability entropy source 830_1, and the second meta-ring oscillator MRO2 may include the second metastability entropy source 830_2 and the third metastability entropy source 830_3. In other words, the number of metastability entropy sources included in the first meta-ring oscillator MRO1 may be 1, while the number of metastability entropy sources included in the second meta-ring oscillator MRO2 may be 2.

As described above, each of the first meta-ring oscillator MRO1 and the second meta-ring oscillator MRO2 may generate a random number based on a metastability signal in a first mode, and in a second mode each of the meta-ring oscillators MRO1 and MRO2 may also operate as a ring oscillator and generate a random number.

In the first meta-ring oscillator MRO1, a first input terminal of a multiplexer MUX1 of the first metastability entropy source 830_1 may be connected to an output terminal of a metastability generator 820_1. In a first mode (e.g., when a mode signal M1 is in a low state), an input terminal of an inverter INV11 may be connected to an output terminal thereof so that the inverter INV11 may generate a metastability signal. A second input terminal of the multiplexer MUX1 of the first metastability entropy source 830_1 may be connected to an output terminal of a first metastability entropy source 830_1. In a second mode (e.g., when the mode signal M1 is in a high state), the inverter INV11 may invert and amplify a signal generated by the same metastability entropy source.

In the second meta-ring oscillator MRO2, a first input terminal of a multiplexer MUX2 may be connected to an output terminal of a metastability generator 820_2, and a first input terminal of a multiplexer MUX3 may be connected to an output terminal of a metastability generator 820_3. In the first mode (e.g., when mode signals M2 and M3 are in a low state), input terminals of the inverters INV21 and INV31 may be connected to output terminals thereof so that the inverters INV21 and INV31 may output metastability signals.

In addition, a second input terminal of the multiplexer MUX2 may be connected to the third metastability entropy source 830_3. A second input terminal of the multiplexer MUX3 may be connected to the second metastability entropy source 830_2. In the second mode (e.g., when the mode signal M2 is in a high state), the inverters INV21 and INV31 may invert and amplify a signal generated by another metastability entropy source.

As compared with the random number generating apparatus 200 of FIG. 2, the random number generating apparatus of FIG. 8 may have more entropy. The random number generating apparatus 200 of FIG. 2 may include only one ring oscillator, while the random number generating apparatus 800 of FIG. 8 may include two ring oscillators and have more entropy than the random number generating apparatus 200. In other words, since each of a first meta-ring oscillator MRO1 and a second meta-ring oscillator MRO2 operates as a separate ring oscillator, the random number generating apparatus 800 may have a higher entropy than the entropy (refer to Equation 6) of the random number generating apparatus 200 of FIG. 2 as shown in Equation 7:

$${ɛ}_{MRO} = {ɛ}_{MS} + {ɛ}_{RO 1} + {ɛ}_{RO 2} = \sum {ɛ}_{MSi} + {ɛ}_{{ϕ}_{01}} + {ɛ}_{{ϕ}_{j 1}} + {ɛ}_{{ϕ}_{0 \; 2}} + {ɛ}_{{ϕ}_{j 2}} . \qquad ( 7 )$$

Furthermore, the random number generating apparatus 800 of FIG. 8 may prevent crosstalk between meta-ring oscillators. Since the number of metastability entropy sources of the first meta-ring oscillator MRO1 is different from the number of metastability entropy sources of the second meta-ring oscillator MRO2, the first meta-ring oscillator MRO1 may have a different frequency from the second meta-ring oscillator MRO2 (referring to Equation 4). As a result, crosstalk between the meta-ring oscillators may be prevented, and an entropy of the random number generating apparatus may increase.

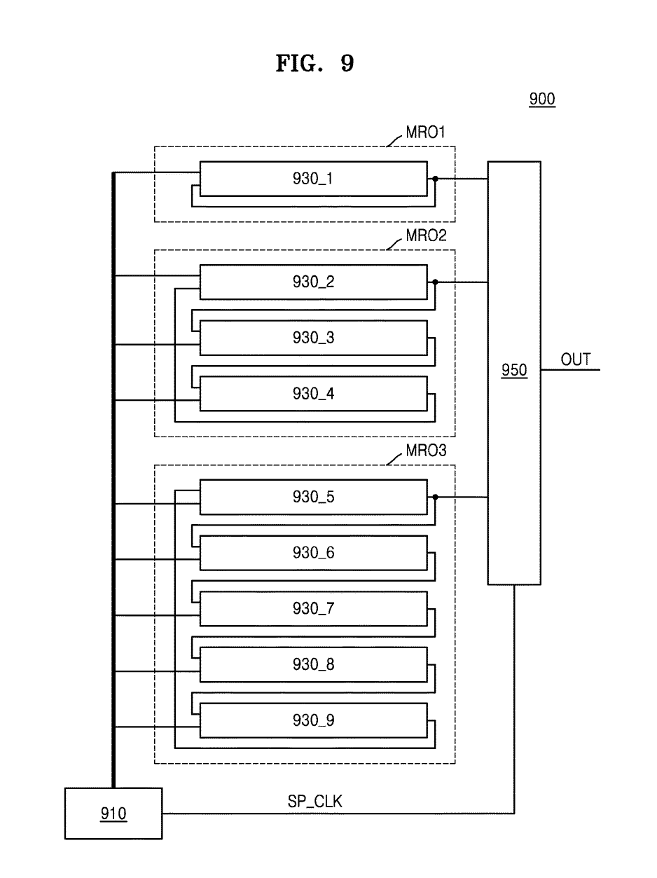

FIG. 9 is a block diagram of a random number generating apparatus 900 according to an exemplary embodiment of the inventive concept. The random number generating apparatus 900 according to the present embodiment may be a modified example of the random number generating apparatus 800 according to the embodiment as shown in FIG. 8. Hereinafter, repeated descriptions in the two embodiments will be omitted.

The random number generating apparatus 900 may include three independent meta-ring oscillators, which may include different numbers of metastability entropy sources.

A first meta-ring oscillator MRO1 may include a first metastability entropy source 930_1. A second meta-ring oscillator MRO2 may include second to fourth metastability entropy sources 930_2, 930_3, and 930_4. A third meta-ring oscillator MRO3 may include fifth to ninth metastability entropy sources 930_5, 930_6, 930_7, 930_8, and 930_9.

When meta-ring oscillators operate as ring oscillators due to a controller 910, the first meta-ring oscillator MRO1 may connect an input terminal of the first metastability entropy source 930_1 with an output terminal of the first metastability entropy source 930_1 and generate a jitter.

An output terminal of the second metastability entropy source 930_2 of the second meta-ring oscillator MRO2 may be connected to an input terminal of the third metastability entropy source 930_3. An output terminal of the third metastability entropy source 930_3 of the second meta-ring oscillator MRO2 may be connected to an input terminal of the fourth metastability entropy source 930_4. An output terminal of the fourth metastability entropy source 930_4 of the second meta-ring oscillator MRO2 may be connected to an input terminal of the second metastability entropy source 930_2, and generate a jitter.

Similarly, the third meta-ring oscillator MRO3 may connect multiple metastability entropy sources to form a closed loop, and generate a jitter.

A sampling unit 950 may generate a random number by using three kinds of jitters that are generated as described above. The random number generating apparatus 900 may accumulate more jitters than a random number generating apparatus including only one ring oscillator, and generate a high-quality random number.

FIG. 10 is a block diagram of a random number generating apparatus 1000 according to an exemplary embodiment of the inventive concept. The random number generating apparatus 1000 according to the present embodiment may be a modified example of the random number generating apparatuses 800 and 900 according to the embodiments shown in FIGS. 8 and 9. Hereinafter, repeated descriptions in these embodiments will be omitted.

Referring to FIG. 10, the number of metastability entropy sources included in a first meta-ring oscillator MRO1 may be less than the number of metastability entropy sources included in a second meta-ring oscillator MRO2. When the meta-ring oscillators operate as ring oscillators, a first cycle signal generated by the first meta-ring oscillator MRO1 may have a shorter cycle (e.g., a higher frequency) than a second cycle signal generated by the second meta-ring oscillator MRO2).

A sampling unit 1050 may be connected to the meta-ring oscillators and to generate a random number. The sampling unit 1050 may sample the first cycle signal and output a random number based on the second cycle signal. The sampling unit 1050 may be synchronized with the second cycle signal.

The sampling unit 1050 may include a first flip-flop FF1 to store a value of a first cycle signal having a high frequency in response to a rising edge (or falling edge) of a second cycle signal having a low frequency. The first cycle signal may be applied to an input signal terminal D of the first flip-flop FF1, and the second cycle signal may be applied to a clock signal terminal of the first flip-flop FF1.

Accordingly, both the input signal and the clock signal applied to the first flip-flop FF1 may be generated by the meta-ring oscillators MRO1 and MRO2 and have jitters. Thus, the first flip-flop FF1 may continuously output irregular values. The second flip-flop FF2 may output the irregular values as random numbers in response to a sampling clock SP_CLK output by a controller 1010.

In an exemplary embodiment of the inventive concept, when the meta-ring oscillators operate in a metastability mode, an amplification signal of a metastability signal may be input to the input signal terminal D and the clock signal terminal of the first flip-flop FF1. In this case, since the metastability signal is irregular, the first flip-flop FF1 may continuously output irregular values, and the second flip-flop FF2 may output the irregular values as random numbers in response to the sampling clock SP_CLK output by the controller 1010.

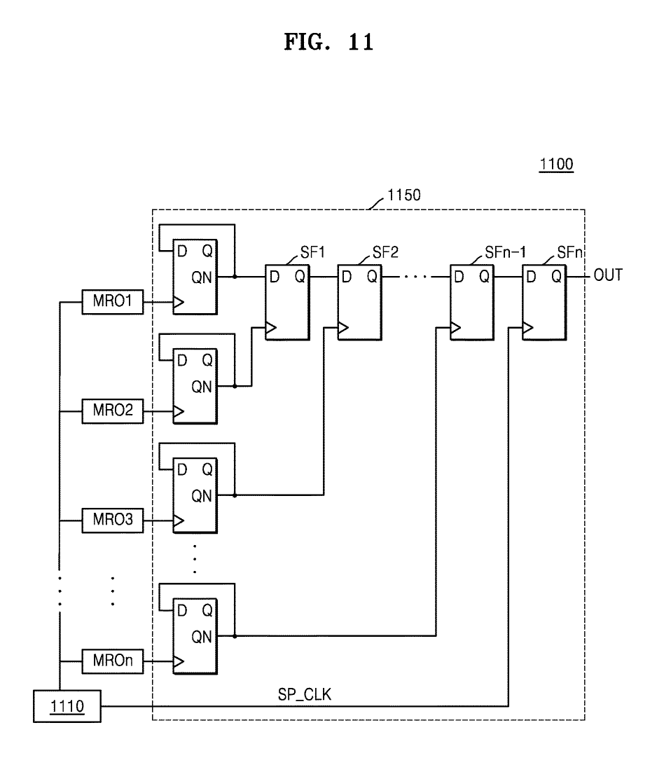

FIG. 11 is a block diagram of a random number generating apparatus 1100 according to an exemplary embodiment of the inventive concept. The random number generating apparatus 1100 according to the present embodiment may be a modified example of the random number generating apparatus 1000 according to the embodiment shown in FIG. 10. Hereinafter, repeated descriptions in the two embodiments will be omitted.

Referring to FIG. 11, the random number generating apparatus 1100 may include n meta-ring oscillators MRO1 to MROn, which may have different metastability entropy sources.

As the numbers of the meta-ring oscillators MRO1 to MROn increases, the meta-ring oscillators MRO1 to MROn may include more metastability entropy sources. For example, a second meta-ring oscillator MRO2 may include more metastability entropy sources than metastability entropy sources included in a first meta-ring oscillator MRO1. Furthermore, a third meta-ring oscillator MRO3 may include more metastability entropy sources than metastability entropy sources included in the second meta-ring oscillator MRO2.

As the number of metastability entropy sources included in the meta-ring oscillator increases, a larger delay may occur due to more inverters so that an oscillation cycle may increase and a frequency may decrease. Accordingly, the meta-ring oscillators MRO1 to MROn may have different cycles (and frequencies). As a result, crosstalk between the meta-ring oscillators MRO1 to MROn may be reduced.

In an exemplary embodiment of the inventive concept, a toggling flip-flop to perform a mod 2 count due to a sufficiently powerful rising edge may be used to accumulate entropy. The random number generating apparatus according to the present embodiment may capture an instantaneous voltage caused by one of the next entropy sources to generate a random number.
In a first mode (metastability mode), a sufficiently powerful instantaneous voltage caused by noise amplification may be captured by the toggling flip-flop and counted.
In a second mode (oscillation mode), a synchronization process may occur. A duration of the synchronization process may vary. For example, the duration of the synchronization process may depend on the intensity of signals output from the meta-ring oscillators MRO1 to MROn (e.g., instantaneous amplification noises of respective stages of a meta-ring oscillator) and related inverter parameters. In general, the synchronization process may relate signals output from the meta-ring oscillators MRO1 to MROn with some initial and random (e.g., run-to-run) phase changes of periodic oscillations. Before ring oscillators generate synchronized nearly stable cycle signals, when random (noise-dependent) fluctuations occur, toggling flip-flops may capture entropies from synchronized signals.

In the oscillation mode, the toggling flip-flops may transmit oscillation phase shifts caused by jitters accumulated in the respective meta-ring oscillators. Each of the toggling flip-flops may be embodied by a mode 2 counter. In an exemplary embodiment of the inventive concept, the toggling flip-flops may be omitted.

A first cycle signal having an oscillation phase shift (e.g., a jitter) caused by the first meta-ring oscillator MRO1 may be transmitted by the toggling flip-flop to a first sampling flip-flop SF1. A second cycle signal having an oscillation phase shift (e.g., a jitter) caused by the second meta-ring oscillator MRO2 may be transmitted by the toggling flip-flop to the first sampling flip-flop SF1. The first sampling flip-flop SF1 of the sampling unit 1150 may be synchronized by the second cycle signal, sample the first cycle signal, and output a first random number signal.

Similarly, the second sampling flip-flop SF2 may be synchronized with a third cycle signal having an oscillation phase shift (e.g., jitter) caused by the third meta-ring oscillator MRO3, sample the first random number signal, and output a second random number signal. The generated random number signal, for example, an n−1-th random number signal may be synchronized with the sampling clock SP_CLK of the controller 1110 due to an n-th sampling flip-flop SFn and output as a final random number signal.

Although FIG. 11 illustrates a D flip-flop as an example of a sampling flip-flop, the inventive concept is not limited thereto. For example, a storage circuit capable of storing data and outputting a stored signal in synchronization with a predetermined signal may be used instead of the D flip-flop.

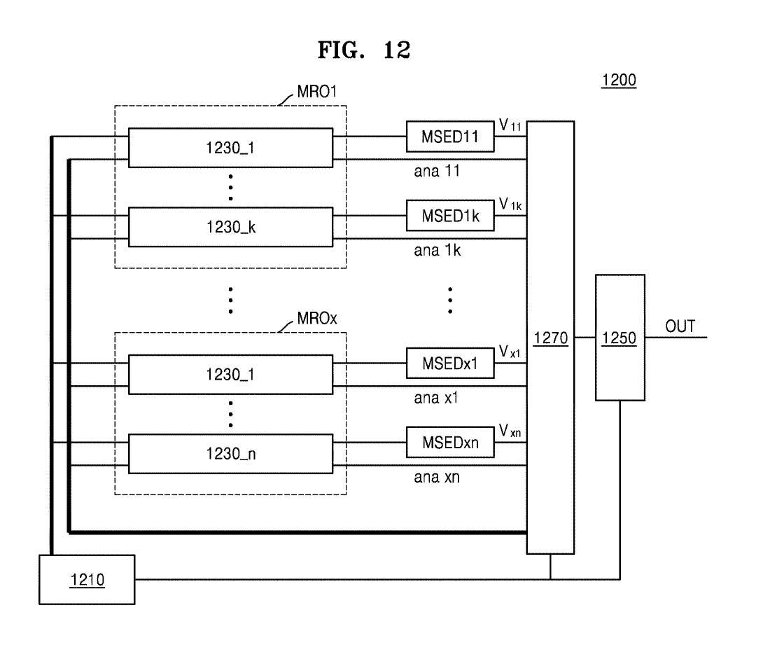

FIG. 12 is a block diagram of a random number generating apparatus 1200 according to an exemplary embodiment of the inventive concept. The random number generating apparatus 1200 according to the present embodiment may be a modified example of the random number generating apparatus 900 according to the embodiment shown in FIG. 9. Hereinafter, repeated descriptions in the two embodiments will be omitted.

Referring to FIG. 12, the random number generating apparatus 1200 may further include a plurality of detectors MSED (e.g. a metastability entropy detector), a setting unit 1270, a sampling unit 1250, and a controller 1210.

In a case where ΔVth<A (noise), the metastability entropy source 1230 or plurality of metastability entropy sources 1230_1-1230_k . . . 1230_1-1230_n, may extract entropy from a thermal noise. Here, ΔVth is a difference (absolute value) between a critical switching value of an inverter (e.g., 11 in FIG. 1) of a metastability generator and an inverter (e.g., 12 in FIG. 1) of an amplifier, and A is a magnitude of the noise.

When circuits are formed variations may occur during the manufacture of the circuits. Variations in the manufacturing process may cause differences in electrical properties to occur. When the value ΔVth is more than A (noise), since a value output by the metastability entropy source 1230 in the first mode is only a fixed value (‘1’ or ‘0’), an entropy of the metastability entropy source 1230 may be substantially 0 (e.g., ε_{MSn}=0). As a result, a meta-ring oscillator may function only as a ring oscillator. However, when ΔVth is less than A (noise), the metastability entropy source 1230 may generate an unstable output, which may result in an initial oscillation phase shift.

The detectors MSED may be respectively connected to the plurality of metastability entropy sources 1230 and to respectively detect entropies (e.g., entropies in the first mode) output by the metastability entropy sources 1230. For example, based on the above-described principles, a first detector MSED11 may measure entropy of a first metastability entropy source 1230_1, generate a first valid signal V11, and transmit the generated first valid signal V11 to the setting unit 1270.

According to an exemplary embodiment of the inventive concept, the detectors may not determine validity of a final random number but determine validity of intermediate random numbers generated by the metastability entropy sources 1230. Accordingly, the detectors MSED may be connected between the metastability entropy sources 1230 and a setting unit 1270.

The setting unit 1270 may receive valid signals (e.g. V₁₁-V₁ₖ . . . Vₓ₁-Vₓₙ) from the detectors MSED and connect the plurality of metastability entropy sources to one another based on the valid signals. The setting unit 1270 may control a plurality of switching blocks based on valid signals (e.g., entropies of the metastability entropy sources 1230 in the first mode), and form a first meta-ring oscillator MRO1 and a second meta-ring oscillator MRO2.

The setting unit 1270 may connect (e.g., reconfigure) the metastability entropy sources 1230 during a manufacturing process, for example, at the beginning or during the manufacturing process (i.e., periodically).

The setting unit 1270 may include volatile and/or non-volatile memory devices to control the plurality of switching blocks. Hereinafter, a reconfiguration operation of the setting unit 1270 will be described in further detail.

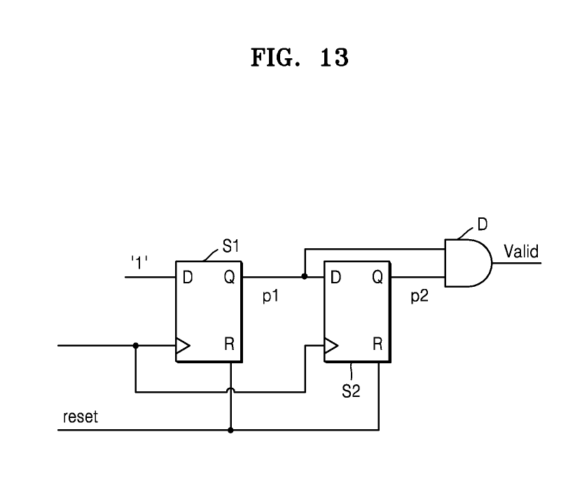

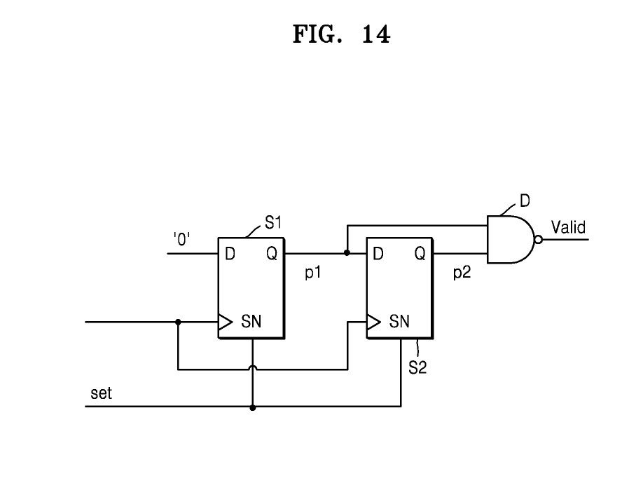

FIGS. 13 and 14 illustrate circuits of a detector MSED of the random number generating apparatus 1200 of FIG. 12 according to an exemplary embodiment of the inventive concept.

Referring to FIG. 13, the detector MSED may detect whether a random number generated based on a metastability signal in a first mode of a metastability entropy source generates the same state signal at least twice.

As described above, when a value ΔVth (absolute value), which is a difference between critical switching values of inverters of the metastability generator and the amplifier is more than A (noise), the metastability entropy source may output only a fixed value (‘1’ or ‘0’) in the first mode. In this case, the detector MSED may generate the same state signal only once. As a result, the detector MSED may output a valid signal having a value ‘0’ indicating that an output value of the metastability entropy source in the first mode does not have entropy.

Conversely, when the value ΔVth (absolute value) is less than A (noise), the metastability entropy source may output a value (‘1’ or ‘0’), which may continuously fluctuate in the first mode. In this case, the detector MSED may generate the same state signal at least twice. As a result, a valid signal may have a value ‘0’, and the detector MSED may output a valid signal having a value ‘1’ indicating that an output value of the metastability entropy source in the first mode has entropy.

To attain the above-described function, the detector MSED may include a first storage unit S1, a second storage unit S2, and a determiner D.

The first storage unit S1 may receive and store a predetermined state signal (e.g., ‘1’) and output the stored state signal in response to a metastability signal of the metastability entropy source. The first storage unit S1 may be embodied by, for example, a first D flip-flop. In this case, an output signal of the metastability entropy source (in the first mode) may be input to a clock input terminal of the first D flip-flop.

The second storage unit S2 may receive and store an output signal of the first storage unit and output the stored signal in response to the meta-stable-state signal of the metastability entropy source. The second storage unit S2 may be embodied by, for example, a second D flip-flop. In this case, an output terminal of the first D flip-flop may be connected to an input terminal of the second D flip-flop. The output signal of the metastability entropy source in the first mode may be input to the clock input terminal of the second D flip-flop.

The determiner D may evaluate the metastability signal based on signals output by the first storage unit and the second storage unit. In the above-described example in which each of the first storage unit S1 and the second storage unit S2 are embodied by a D flip-flop, the determiner D may be embodied by, for example, an AND gate. If an output signal p1 of the first D flip-flop and an output signals p2 of the second D flip-flop is ‘1’, the determiner D may indicate that the metastability entropy source outputs a signal ‘1’ at least twice. In other words, a signal output by the corresponding metastability entropy source (in the first mode) may have valid entropy. Thus, the AND gate may output a signal ‘1’ indicating validity.

If the metastability entropy source outputs a signal ‘1’ once or less and a signal output by the metastability entropy source (in the metastability mode) is determined to not have entropy, the AND gate may output a signal ‘0’ indicating invalidity. In this case, a setting unit may exclude the metastability entropy source from the entire circuit or form a ring oscillator based only the metastability entropy sources. As a result, high-quality random numbers may be generated, and the use of low-quality metastability entropy sources may be excluded. Excluding low-quality metastability entropy sources may reduce the power usage of the random number generator.

FIG. 14 illustrates an exemplary embodiment of the inventive concept in which a predetermined state signal is a signal ‘0’ and a determiner is embodied by a NAND gate. For reference, FIG. 13 illustrates an exemplary embodiment of the inventive concept in which a predetermined state signal is a signal ‘1’ and a determiner is embodied by an AND gate.

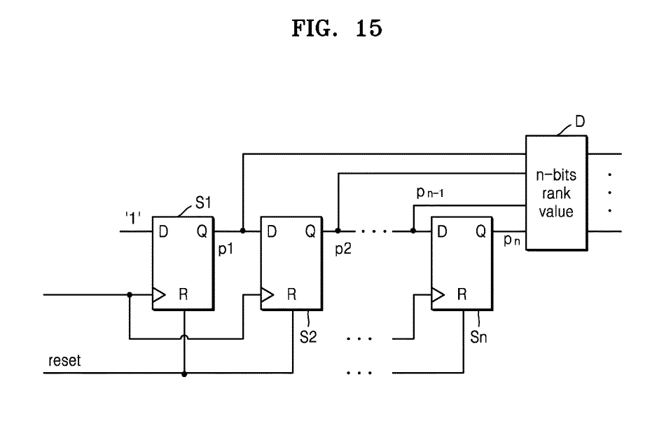

FIG. 15 shows modified examples of the detector MSED of FIG. 13 according to an exemplary embodiment of the inventive concept. Hereinafter, repeated descriptions will be omitted.

Referring to FIG. 15, a detector may include a component to not only determine validity of a metastability signal of a metastability entropy source but also measure quality of the metastability signal.

The detector may include n storage units S1, S2, . . . , and Sn to receive a metastability signal as a clock signal. A determiner D may determine a quality of the metastability signal based on output signals p1 to pn of the n storage units.

When the metastability entropy source outputs a signal ‘1’ five times, a rank determiner of the determiner D may output a binary signal (e.g., ‘101’) corresponding to five times. In addition, when the metastability entropy source outputs the signal ‘1’ 11 times, the determiner D may output a binary signal (e.g., ‘1011’) corresponding to 11 times.

The same state signal may be continuously output during one time section (e.g., a time section for which a reset signal R is input) if the metastability entropy source has a sufficient quantity of entropies. Accordingly, as a higher binary signal is generated by the determiner D, the metastability entropy source may generate a higher quality random number.

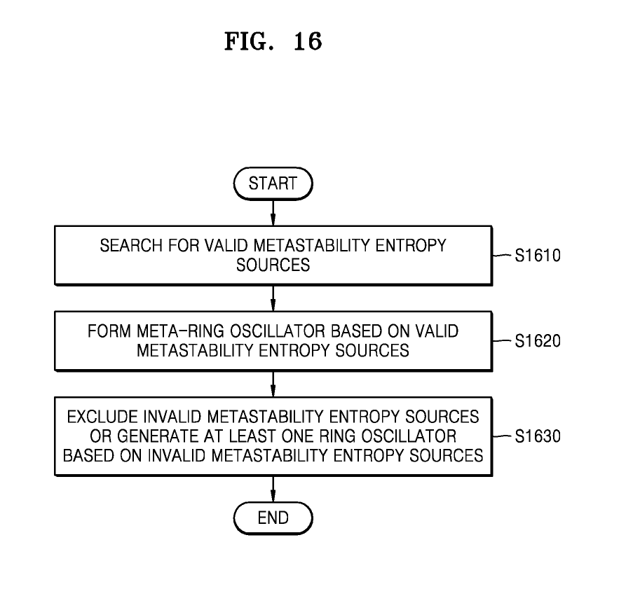

FIG. 16 is a schematic flowchart of a method of operating a random number generating apparatus according to an exemplary embodiment of the inventive concept.

Referring to FIG. 16, valid metastability entropy sources may be searched (S1610). If valid metastability entropy sources (or metastability entropy sources having high entropies) are detected among a plurality of metastability entropy sources, a meta ring oscillator may be formed based on the valid metastability entropy sources (S1620). Invalid metastability entropy sources may be excluded, and a ring oscillator may be formed based on only the invalid metastability entropy sources (S1630).

The invalid metastability entropy sources, although invalid, indicate that only entropy of a metastability signal generated in a first mode is 0. Thus, the invalid metastability entropy sources may still operate as the ring oscillator. Accordingly, the invalid metastability entropy sources may be connected to one another in operation S1630 to form an additional random number generator.

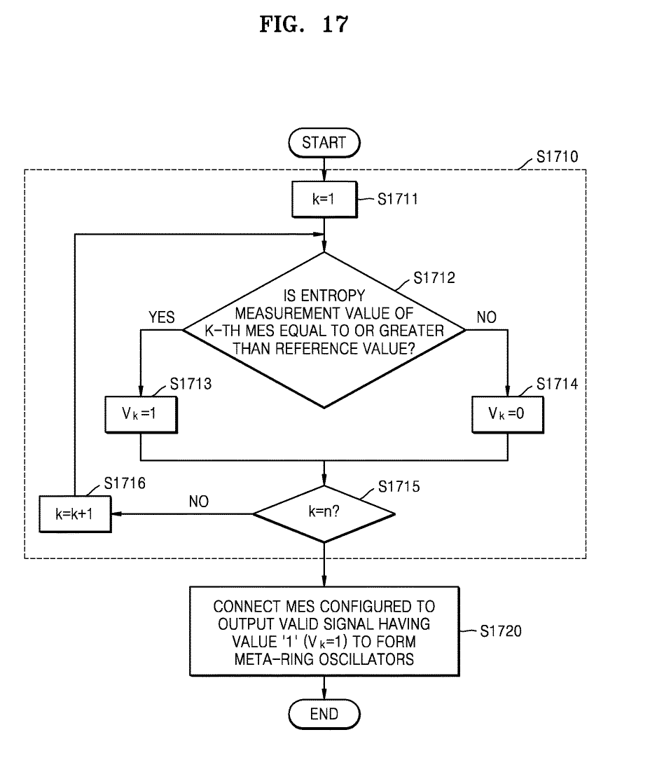

FIG. 17 is a block diagram of a method of operating a random number generating apparatus according to an exemplary embodiment of the inventive concept. The method according to the present embodiment is a modified example of the method according to the embodiment shown in FIG. 16. Hereinafter, repeated descriptions in the two embodiments will be omitted.

Referring to FIG. 17, to search for valid metastability entropy sources (S1710), a value k may be set to equal to 1 (k=1) (S1711). An entropy measurement value of a k-th metastability entropy source MES is determined to be equal to or greater than a reference value (S1712). For example, the reference value represents the amount of entropy of a metastability entropy source that can generate a random number. If the entropy measurement value of the k-th metastability entropy source MES is equal to or greater than the reference value, a valid signal Vk having a value ‘1’ may be output (S1713). If the entropy measurement value of the k-th metastability entropy source MES is less than the reference value, a valid signal Vk having a value ‘0’ may be output (S1714). The value k is compared to n (S1715). If the value k does not reach n, the value k may be increased (e.g., k+1), and operations S1711 to S1714 may be repeated.

If validity of all the metastability entropy sources is detected, the metastability entropy sources outputting valid signals Vk having a value ‘1’ (Vk=1) may be connected to one another and form one or more meta-ring oscillators (S1720).

A method of operating a random number generating apparatus according to an exemplary embodiment of the inventive concept may include, for example, obtaining entropy values of metastability entropy sources by using the detector shown in FIG. 15, searching for metastability entropy sources having entropies equal to or greater than a specific value, and forming meta-ring oscillators based on the metastability entropy source having the entropies equal to or greater than the specific value. For example, the specific value represents a level of entropy greater than the reference value.

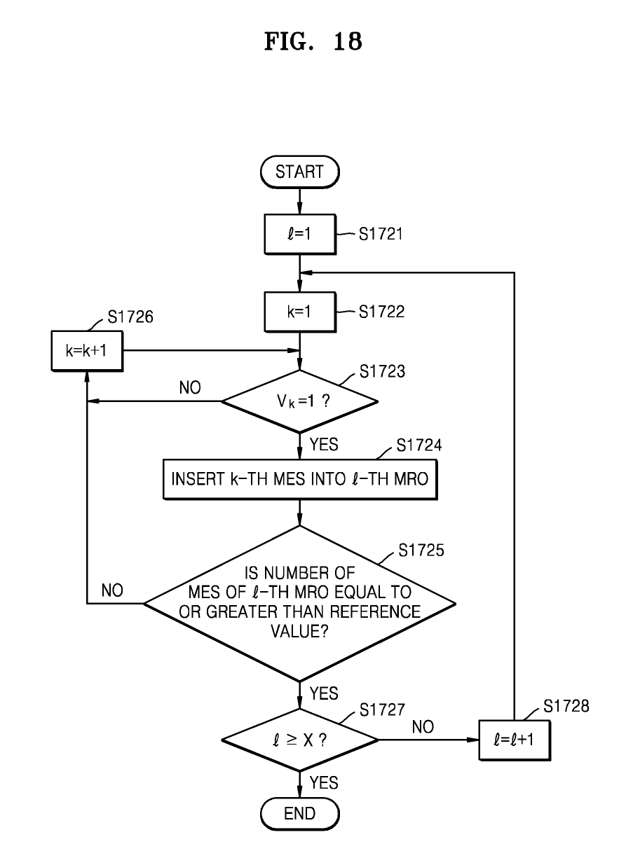

FIG. 18 is a detailed diagram of an operation S1720 of forming a meta-ring oscillator of FIG. 17.

Referring to FIG. 18, l may be set to equal to 1 (l=1) (S1721), and k may be set to equal to 1 (k=1) (S1722). A k-th metastability entropy source may be determined to be valid (S1723). When the k-th metastability entropy source is determined as valid, the k-th metastability entropy source may be classified into an l-th meta-ring oscillator (S1724). When the k-th metastability entropy source is not determined as valid, a value k may be increased (e.g. k+1) (S1726), and operation S1723 may be repeated.

After the operation S1724 is ended, the number of metastability entropy sources of the l-th meta-ring oscillator may be determined to be equal to or greater than a reference value (S1725). If the number of the metastability entropy sources of the l-th meta-ring oscillator is less than the reference value, the value k may be increased (S1726), and the operations S1723 and S1724 may be repeated. After operation S1725, a value 1 may be determined if the value 1 has reached a value x (S1727). For example, the value x represents the maximum number of metastability entropy sources that can be included in a meta-ring oscillator. Otherwise, the value 1 may be increased (S1728), and operations S1721 to S1727 may be repeated.

By classifying a valid metastability entropy source into a meta-ring oscillator as described above, an entropy shown in Equation 7 may be obtained.

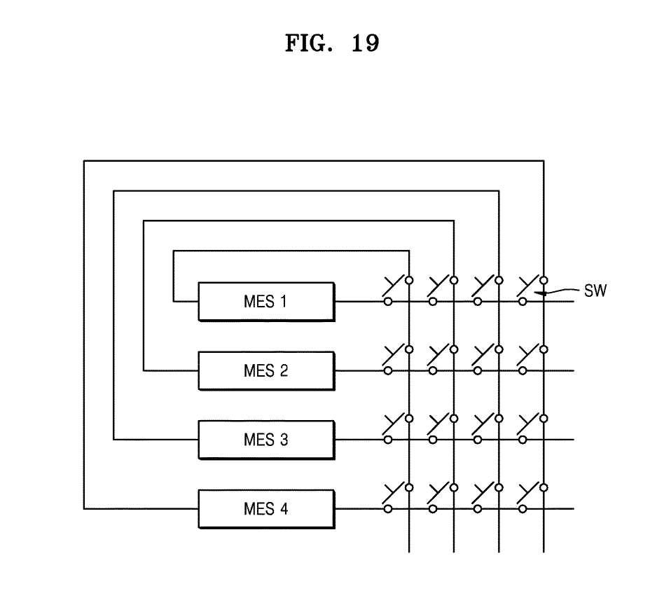

FIGS. 19 to 21 are diagrams of random number generating apparatuses according to exemplary embodiments of the inventive concept. For example, FIGS. 19 to 21 illustrate a process of connecting metastability entropy sources by using a setting unit and forming a meta-ring oscillator by using the above-described method of operating the random number generating apparatus.

Referring to FIG. 19, the setting unit of the random number generating apparatus may include switching blocks SW. When the number of metastability entropy sources is n, the number of the switching blocks SW may be n². The switching blocks SW may be turned on or turned off by a controller so that the metastability entropy sources may be connected to one another. Meta-ring oscillators may be formed as a result of the connections of the metastability entropy sources.

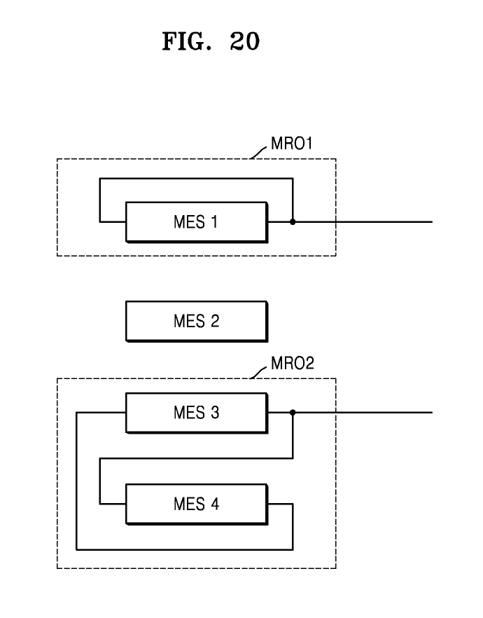

For example, the random number generating apparatus may be formed as shown in FIG. 20 on the following conditions.
Condition 1: An entropy of a second metastability entropy source MES2 of first to fourth metastability entropy sources MES1 to MES4 is 0 in a first mode.
Condition 2: The first meta-ring oscillator MRO1 is embodied by one metastability entropy source, and the second meta-ring oscillator MRO2 is embodied by two metastability entropy sources.

Since an the entropy of the second metastability entropy source MES2 in the first mode is 0, the second metastability entropy source MES2 may be excluded from the formation of meta-ring oscillators. As a result, the first metastability entropy source MES1 may form the first meta-ring oscillator MRO1, and the third and fourth metastability entropy sources may form the second meta-ring oscillator MRO2.

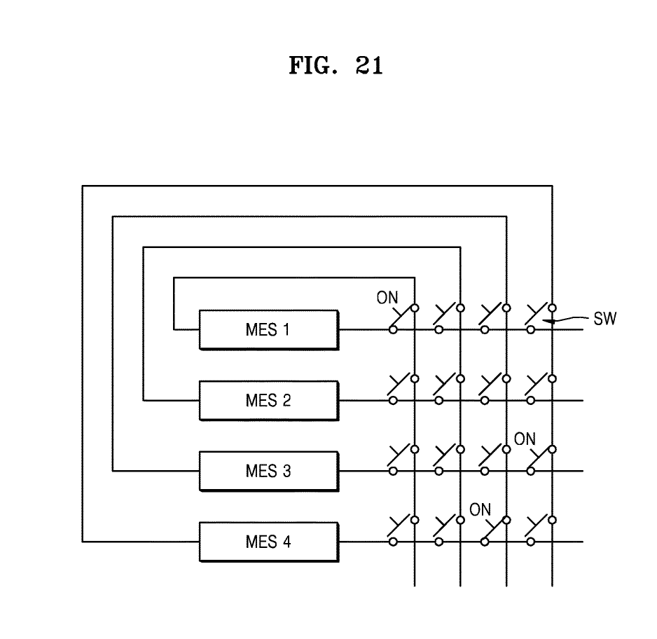

The controller may generate a control signal for controlling the switching block based on the conditions 1 and 2. The setting unit may connect, turn on, and turn off the switching block based on the control signal and connect the metastability entropy sources to one another. The control signal may be stored in volatile and/or non-volatile memory devices. FIG. 21 illustrates a state in which three switching blocks SW are turned on to create the connections to obtain the random number generating apparatus of FIG. 20.

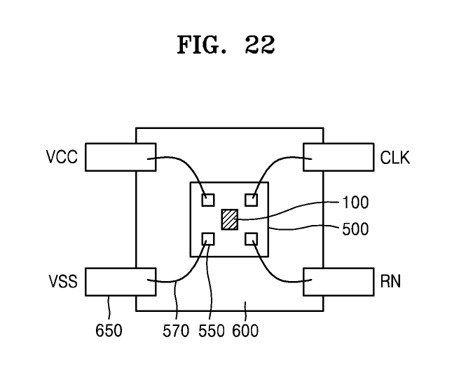

FIG. 22 is a schematic plan view of a semiconductor package including a random number generating apparatus 100 according to an exemplary embodiment of the inventive concept. The semiconductor package according to the present embodiment may include a random number generating apparatus according to one of the above-described embodiments.

Referring to FIG. 22, the random number generating apparatus 100 may be provided on a semiconductor chip 500, which may be mounted on a printed circuit board (PCB) 600. A chip pad 550 of the semiconductor chip 500 may be electrically connected to an external terminal 650 of the PCB 600 via a bonding wire 570. The plurality of external terminals and the plurality of bonding wires connected to the semiconductor chip 500 may be referred to as the external terminal 650 and the bonding wire 570 respectively. Each of the first power supply VCC, a second power supply VSS, and a clock signal CLK may be applied by external terminals 650 via the bonding wires 570 to the semiconductor chip 500. A random signal RN generated by the random number generating apparatus 100 may be output to the external terminal 650 via the chip pad 550 and the bonding wire 570. A packaging method shown in FIG. 20 is an exemplary embodiment of the inventive concept, and semiconductor packages may be formed by using various other packaging methods.

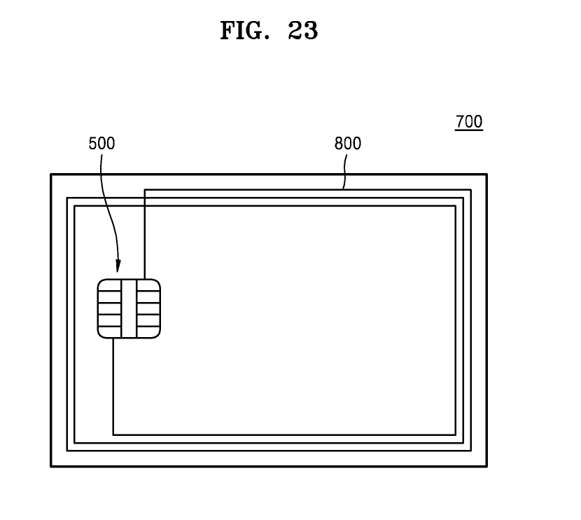

FIG. 23 is a schematic plan view of a smart card 700 including a random number generating apparatus according to an exemplary embodiment of the inventive concept. The smart card 700 according to the present embodiment may include a random number generating apparatus according to one of the above-described exemplary embodiments.

A card reader authenticates the smart card 700) to authenticate a card owner. For example, to perform authentication, the card reader may receive authentication information stored in the smart card 700 and determine if the authentication information is valid. An appropriate algorithm for encrypting the authentication information and a random number generating apparatus to use the algorithm may be used to maintain the security of the authentication information.

The semiconductor chip 500 may include a random number generating apparatus according to an exemplary embodiment of the inventive concept to perform an authentication function.

The antenna 800 may receive power from the card reader and transmit the power to the semiconductor chip 500. The antenna 800 may also transmit encrypted authentication information generated by the semiconductor chip 500 to the card reader.

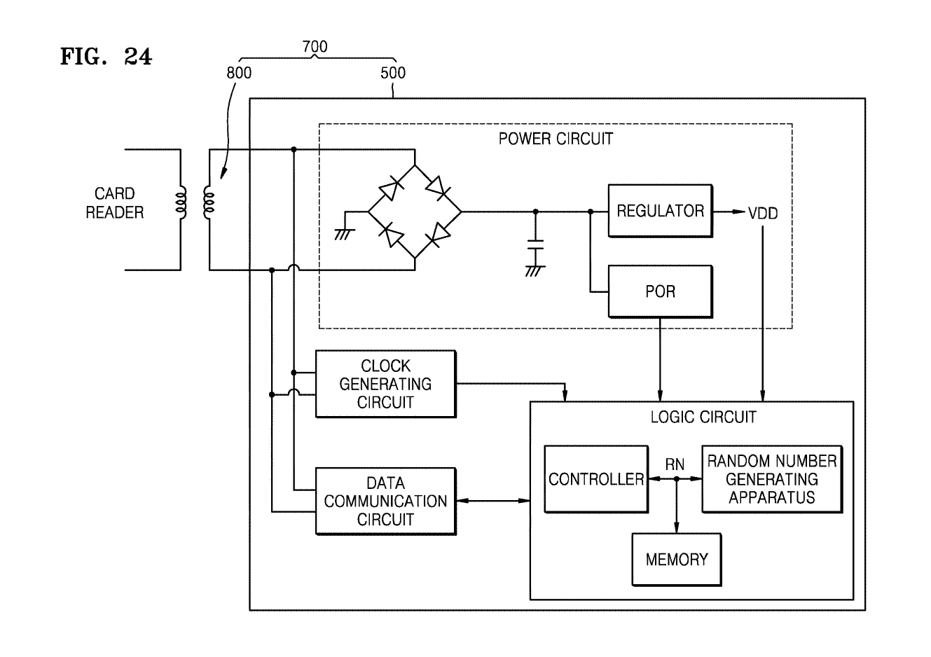

FIG. 24 is a circuit diagram of a semiconductor chip 500 of the smart card 700 of FIG. 23 according to an exemplary embodiment of the inventive concept.

Referring to FIG. 24, the semiconductor chip 500 may include a power circuit, a clock generating circuit, a logic circuit, and a data communication circuit.

The power circuit may generate direct-current (DC) power based on an alternating current (AC) signal received from an antenna 800. Also, the power circuit may include a power-on reset (POR) circuit to reset stored data with an application of power.

The clock generating circuit may convert the AC signal received from the antenna 800 into a clock signal CLK and apply the clock signal CLK to the logic circuit.

The logic circuit may include a controller, a memory, and a random number generating apparatus. The random number generating apparatus may generate random signals RN. Since the configuration of the random number generating apparatus is similar to the above-described embodiments, detailed descriptions thereof are omitted. The controller may encrypt authentication information based on the random signal RN generated by the random number generating apparatus. The memory may function to store authentication information, the random signals RN, and encrypted authentication information.

The data communication circuit may process information received from the card reader via the antenna 800 and transmit the processed information to the logic circuit. The data communication circuit may process the encrypted authentication information generated by the logic circuit and transmit the processed encrypted authentication information to the card reader via the antenna 800.

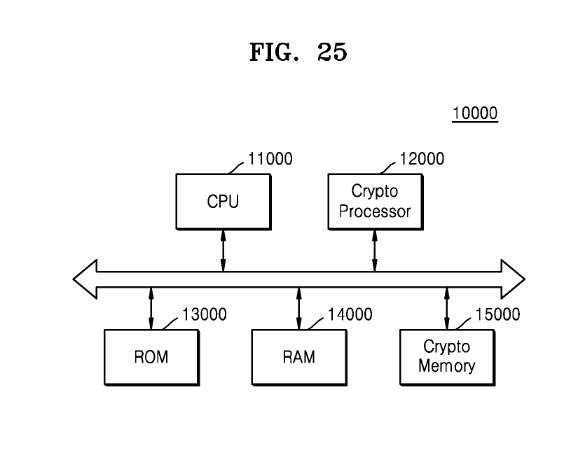

FIG. 25 is a block diagram of a security system 10000 including a crypto processor having a random number generating apparatus according to an exemplary embodiment.

Referring to FIG. 25, the security system 10000 may include a central processing unit (CPU) 11000, a crypto processor 12000, a read-only memory (ROM) 13000, a random-access memory (RAM) 14000, and a crypto memory 15000. The CPU 11000 may control the overall operations of the security system 10000. The crypto processor 12000 may decrypt commands to enable encryption, authentication, electronic signature and process data under the control of the CPU 11000. The crypto processor 12000 may include the above-described random number generating apparatus. The ROM 13000 and the RAM 14000 may store data required to drive the security system 10000. The crypto memory 15000 may store data required to drive the crypto processor 12000.

While the inventive concept has been particularly shown and described with reference to exemplary embodiments thereof, it will be apparent to those of ordinary skill in the art that various changes in form and detail may be made thereto without departing from the spirit and scope of the inventive concept as defined by the following claims.

What is claimed is:

1. An apparatus for generating a random number, the apparatus comprising:
a plurality of metastability entropy sources;
a first meta-ring oscillator including a first portion of the plurality of metastability entropy sources; and
a second meta-ring oscillator including a second portion of the plurality of metastability entropy sources,
wherein each of the first meta-ring oscillator and the second meta-ring oscillator is configured to generate a first random number based on a metastability signal in a first mode and operate as a ring oscillator to generate a second random number in a second mode,
a number of metastability entropy sources included in the first meta-ring oscillator is less than a number of metastability entropy sources included in the second meta-ring oscillator.

2. The apparatus of claim 1, wherein in the second mode, a frequency of a first cycle signal generated by the first meta-ring oscillator is greater than a frequency of a second cycle signal generated by the second meta-ring oscillator.

3. The apparatus of claim 1, further comprising at least one sampling circuit,
wherein the sampling circuit is configured to sample a first cycle signal in synchronization with a second cycle signal and output the second random number.

4. The apparatus of claim 1, wherein at least one of the plurality of metastability entropy sources comprises:
an inverter configured to invert an input signal and output the inverted signal; and
an amplifier configured to amplify an output signal of the inverter,
wherein in the first mode, an input terminal of the inverter is connected to an output terminal of the inverter.

5. The apparatus of claim 1, further comprising a plurality of metastability entropy detectors respectively connected to the plurality of metastability entropy sources and configured to detect an entropy of each of the metastability entropy sources in the first mode.

6. The apparatus of claim 5, further comprising a sampling circuit configured to sample the second random number using the first meta-ring oscillator and the second meta-ring oscillator,
wherein the entropy detectors are connected between the plurality of metastability entropy sources and the sampling circuit.

7. The apparatus of claim 5, further comprising a setting circuit configured to connect the plurality of metastability entropy sources to one another,

8. The apparatus of claim 7, wherein the setting circuit comprises a plurality of switching blocks,
wherein the setting circuit is configured to control the plurality of switching blocks based on the entropy and form the first meta-ring oscillator and the second meta-ring oscillator.

9. The apparatus of claim 5, wherein at least one of the plurality of metastability entropy detectors is configured to determine whether the first random number generated in the first mode by the metastability entropy source has a valid entropy by evaluating the metastability signal for a same state signal at least twice.

10. The apparatus of claim 5, wherein at least one of the plurality of metastability entropy detectors comprises a first flip-flop, and
an output signal of the metastability entropy source in the first mode is input to a clock input terminal of the first flip-flop.

11. The apparatus of claim 10, wherein the at least one of the plurality of metastability entropy detectors further comprises a second flip-flop,
an output terminal of the first flip-flop is connected to an input terminal of the second flip-flop, and
the output signal of the metastability entropy source in the first mode is input to a clock input terminal of the second flip-flop.

12. An apparatus for generating a random number, the apparatus comprising:
a first meta-ring oscillator including a metastability generator configured to generate a metastability signal and an amplifier configured to amplify the metastability signal; and
a second meta-ring oscillator including a plurality of random number generators,
wherein in the second meta-ring oscillator each of the plurality of random number generators generates a metastability signal in a first mode, and
the plurality of random number generators are connected to one another and operate as a ring oscillator in a second mode.

13. The apparatus of claim 12, wherein in the second mode, an output of the amplifier is input to the metastability generator, and the first meta-ring oscillator generates a first cycle signal, and
a second cycle signal generated by the second meta-ring oscillator in the second mode has a lower frequency than a frequency of the first cycle signal.

14. An apparatus for detecting metastability entropy, the apparatus comprising:
a first storage circuit configured to receive and store a predetermined state signal and output the predetermined state signal in response to a metastability signal of a metastability entropy source;
a second storage circuit configured to receive and store the predetermined state signal of the first storage unit and output the predetermined state signal in response to the metastability signal of the metastability entropy source; and
a determining circuit configured to evaluate the metastability signal based on the predetermined state signals of the first storage circuit and the second storage circuit.

15. An apparatus for generating a random number, the apparatus comprising:
a plurality of metastability entropy sources;
a plurality of metastability entropy detectors respectively connected to the plurality of metastability entropy sources and configured to detect an entropy of a metastability signal output by each of the metastability entropy sources; and
a setting circuit configured to connect the plurality of metastability entropy sources to one another,
wherein a first group of metastability entropy sources, among the plurality of metastability entropy sources, are connected to one another by the setting circuit and form a first meta-ring oscillator,
a second group of metastability entropy sources, among the plurality of metastability entropy sources, are connected to one another and form a second meta-ring oscillator, and
each of the first meta-ring oscillator and the second meta-ring oscillator is configured to generate a first random number based on the metastability signal in a first mode and operate as a ring oscillator and generate a second random number in a second mode.

16. A random number generator comprising:
a plurality of metastability entropy sources.
wherein each of the plurality of metastability entropy sources generates a random number in a first mode,
wherein one or more meta-ring oscillators are formed from the plurality of metastability entropy sources in a second mode and generate an output signal based on the random number, and
wherein each meta-ring oscillator includes at least one metastability entropy source.

17. The random number generator of claim 16, wherein the random number generator comprises:
a first inverter,
a second inverter, and
a mulitiplexer that connects an output of the first inverter to an input of the first inverter in the first mode and connects the output of the first inverter of a first metastability entropy source in a meta-ring oscillator to an input of the second inverter of a second metastability entropy source in the meta-ring oscillator in the second mode.

18. The random number generator of claim 16, further comprising:
a controller; and
a sampling circuit that generates a sampling signal based on the output signal from the plurality of metastability entropy sources in the second mode and a clock signal received from the controller.

19. The random number generator of claim 16, further comprising:
a detecting circuit that determines if each of the plurality of metastability entropy sources has entropy based on the output signal of each of the plurality of metastability entropy sources, and
wherein metastability entropy sources without entropy are excluded from the meta-ring oscillators.

20. The random number generator of claim 19, further comprising:
a plurality of switching blocks including a plurality of transistors that connect the metastability entropy sources for the meta-ring oscillators based on the determination of the detecting circuit.
